(19) United States
(12) Patent Application Publication
(10) Pub. No.: US 2006/0155583 A1
(43) Pub. Date: Jul. 13, 2006

(54) Medical apparatus and method for controlling access to medical data

(75) Inventors: Fumiaki Teshima, Nasushiobara-shi (JP); Kousuke Sakaue, Nasushiobara-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: KABUSHIKI KAISHA TOSHIBA, Minato-ku (JP); TOSHIBA MEDICAL SYSTEMS CORPORATION, Otawara-shi (JP)

(21) Appl. No.: 11/287,447

(22) Filed: Nov. 28, 2005

(30) Foreign Application Priority Data
Nov. 29, 2004 (JP) 2004-344472

(51) Int. Cl. G06F 19/00; G06F 17/30

(52) U.S. Cl. 705/3; 707/9

(57) ABSTRACT

A medical apparatus includes an operator attribute information storing unit, a medical data storing unit, a data authorship information storing unit, and an access control unit. The operator attribute information storing unit stores attribute information of an operator as operator attribute information. The medical data storing unit stores medical data. The data authorship information storing unit stores authorship information of medical data as data authorship information. The access control unit performs access control so as to control an access of the operator to medical data by using the operator attribute information and the data authorship information.

### BACKGROUND OF THE INVENTION

1. Field of the Invention

The present invention relates to a medical apparatus which can judge accessibility to medical data according to the relationship between an operator who wants to access medical data, such as medical image data or the like, and the authorship of medical data, and to a method of controlling an access to medical data.

2. Description of the Related Art

In the related art, the management of an access to data (information) stored in various system, such as a computer and the like, has been performed. In a related art access management technology, a method of imparting a predetermined function to a user or a group to which the user belongs is used. That is, a technology has been suggested in which an authority to read out, write, delete or execute predetermined data or device is imparted to the user or group. And then, by managing a security policy and performing authentication with an ID or password so as to judge accessibility, an unauthorized access to various kinds of data is limited. (For example, see Linux Documentation Project Guides, [online], Last Modified: 2004-11-03, [searched on Nov. 19, 2004], Internet <URL: http://www.tldp.org/guides.html>).

For example, a commercial operating system which can set executable functions for the groups to which the users belong has been implemented. And then, for example, for each file or directory, a user or user group to which an authority to read out, write, delete or execute the file or directory is imparted can be set.

However, in the case of protecting medical data as personal information of a patient stored in a medial apparatus, such as a medical image diagnosis apparatus or a hospital information system (HIS), if accessibility judgment is based on only the user (operator) or the group to which the user belongs, it may be difficult to perform suitable access control.

That is, the access authority to medical data stored in the medical apparatus needs to be determined by referring to the relationship between the user or the group to which the user belongs, and the authorship of medical data, in addition to identification information of the user or the group to which the user belongs. For example, when a patient receives the medical treatment or examination of a doctor or an engineer, it is preferable that only a doctor or an engineer having direct or indirect relation to the examination can access medical data of the patient.

However, in the related art access control technology in which the access authority of the user or the group to data is realistically described, accessibility of each user or group to all medical data is determined in advance, and then the access control is performed according to identification information of the user or the group. As a result, when an exclusive and strict access control is to be executed, setting or change of the access authority is complex, and actual application is not realistic.

### SUMMARY OF THE INVENTION

The present invention has been finalized in view of the drawbacks inherent in the related art, and it is an object of the present invention to provide a medical apparatus which can judge accessibility of medical data according to the relationship between an operator who wants to access medical data, such as medical image data or the like, and the authorship of medical data, and a method of controlling an access to medical data.

In order to solve the above-described object, according to a first aspect of the invention, a medical apparatus includes an operator attribute information storing unit that stores attribute information of an operator as operator attribute information, a medical data storing unit that stores medical data, a data authorship information storing unit that stores authorship information of medical data as data authorship information, and an access control unit that performs access control so as to control an access of the operator to medical data by using the operator attribute information and the data authorship information.

Further, in order to solve the above-described object, according to a second aspect of the invention, a medical apparatus includes an operator attribute information storing unit that stores attribute information of an operator as operator attribute information, a medical data storing unit that stores medical data, a data authorship information storing unit that stores authorship information of medical data as data authorship information, an access control information creating unit that creates access control information so as to control an access of the operator to medical data by using at least one of the operator attribute information and the data authorship information, an access control information storing unit that stores the access control information, an access control information acquiring unit that acquires the access control information from the access control information storing unit, an operator attribute information acquiring unit that acquires the operator attribute information required for judging accessibility according to the access control information acquired by the access control information acquiring unit from the operator attribute information storing unit, a data authorship information acquiring unit that acquires the data authorship information required for judging accessibility according to the access control information acquired by the access control information acquiring unit from the data authorship information storing unit, and an accessibility judging unit that judges accessibility of the operator to medical data on the basis of at least one of the operator attribute information received from the operator attribute information acquiring unit and the data authorship information received from the data authorship information acquiring unit according to the access control information received from the access control information acquiring unit, and performs access limitation to unpermitted medical data.

Further, according to a third aspect of the invention, a method of controlling an access to medical data includes storing attribute information of an operator as operator attribute information, storing medical data, storing authorship information of medical data as data authorship information, and performing access control so as to control an access of the operator to medical data by using the operator attribute information and the data authorship information.

Further, according to a fourth aspect of the invention, a method of controlling an access to medical data includes creating access control information so as to control an access of an operator to medical data stored in a medical apparatus by using at least one of attribute information of the operator stored as operator attribute information and authorship information of medical data stored as data authorship information in the medical apparatus, storing the access control information, acquiring the access control information from the stored access control information, acquiring the operator attribute information required for judging accessibility according to the acquired access control information, acquiring the data authorship information required for judging accessibility according to the acquired access control information, and judging accessibility of the operator to medical data on the basis of at least one of the acquired operator attribute information and data authorship information according to the acquired access control information, and performing access limitation to unpermitted medical data.

In such a medical apparatus and a method of controlling an access to medical data according to the invention, accessibility to medical data can be judged according to the relationship between an operator who wants to access medical data, such as medical image data or the like, and the authorship of medical data.

### BRIEF DESCRIPTION OF THE DRAWINGS

FIG. 1 is a functional block diagram showing an embodiment of a medical image diagnosis apparatus which is an example of a medical apparatus of the invention;

FIG. 2 is a conceptual view showing an example of the relationship among medical data, an access to which is controlled by the medical image diagnosis apparatus shown in FIG. 1, a patient, an operator, and an access person;

FIG. 3 is a diagram showing an example of operator attribute information which is stored in an operator attribute information storing unit of the medical image diagnosis apparatus shown in FIG. 1;

FIG. 4 is a diagram showing an example of data authorship information which is stored in a data authorship information storing unit of the medical image diagnosis apparatus shown in FIG. 1;

FIG. 5 is a diagram showing an example of access control information which is created by an access control information creating unit of the medical image diagnosis apparatus shown in FIG. 1; and

FIG. 6 is a flowchart showing a process when an access to medical data is controlled by the medical image diagnosis apparatus shown in FIG. 1.

### DESCRIPTION OF THE PREFERRED EMBODIMENTS

Embodiments of a medical apparatus and a method of controlling an access to medical data according to the invention will be described with reference to the accompanying drawings.

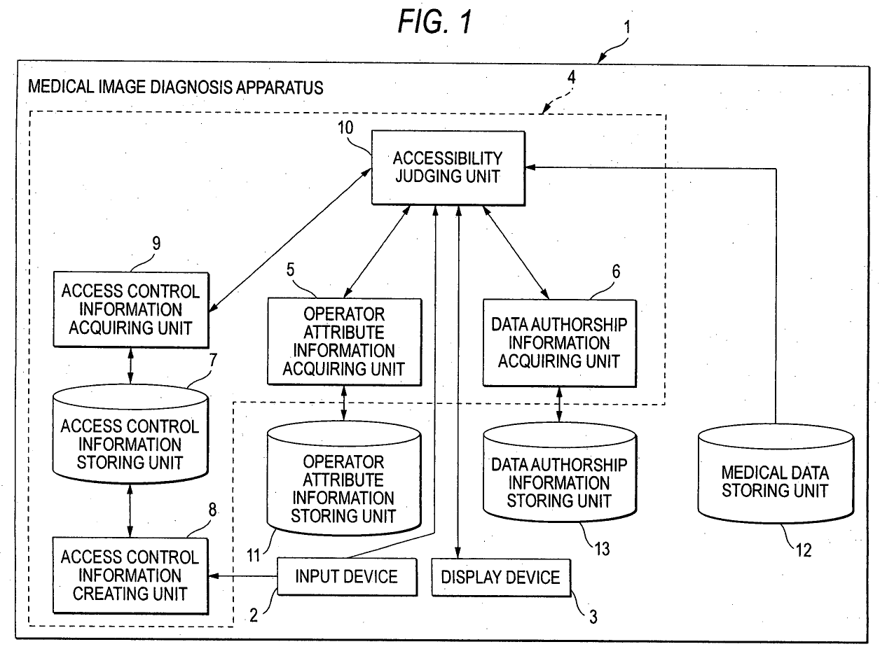

FIG. 1 is a functional block diagram showing an embodiment of a medical image diagnosis apparatus which is an example of the medical apparatus according to the invention.

The medical image diagnosis apparatus 1 includes an input device 2 and a display device 3. On the medical image diagnosis apparatus 1, a medical data access control system 4 is mounted. The medical image diagnosis apparatus 1 can be an arbitrary apparatus, such as a magnetic resonance imaging (MRI) apparatus, an X-ray computed tomography (CT) apparatus, an ultrasonic diagnosis apparatus, a positron emission computed tomography (PET) apparatus, and an X-ray diagnosis apparatus. Further, in addition to the medical image diagnosis apparatus 1, a medical data access control system 4 can be mounted on a medical apparatus which includes an arbitrary medical system, such as a hospital information system (HIS) or the like. In addition, the medical data access control system 4 can be mounted on the arbitrary medical apparatus without being clearly separated from other systems. To the contrary, the medical data access controls system 4 may be an independent system which is not mounted on the medical apparatus.

Moreover, in the medical image diagnosis apparatus 1 shown in FIG. 1, only the minimum configuration of the medical data access control system 4 and the configuration having relation to the operation of the medical data access control system 4 are shown. The configurations which perform other processing, such as data collection, imaging of collected data, and clinical application measurement, are not shown, and the descriptions of the operations thereof will be omitted.

The medical data access control system 4 is a system which reads a medical data access control program in a computer constituting the medical image diagnosis apparatus 1 so as to cause the computer to function an operator attribute information acquiring unit 5, a data authorship information acquiring unit 6, an access control information storing unit 7, an access control information creating unit 8, an access control information acquiring unit 9, and an accessibility judging unit 10. The medical data access control system 4 is a system which executes access control of medical data stored in the medical image diagnosis apparatus 1 by a method of controlling an access to medical data according to the invention. These parts can be individually constructed by software as subsystems or can be constructed as a single system.

Further, as the configuration having relation to the operation of the medical data access control system 4, in the medical image diagnosis apparatus 1, an operator attribute information storing unit 11, a medical data storing unit 12, and a data authorship information storing unit 13 are provided. However, the operator attribute information storing unit 11, the medical data storing unit 12, and the data authorship information storing unit 13 may be the parts of the medical data access control system 4.

Moreover, the access control information storing unit 7, the operator attribute information storing unit 11, and the data authorship information storing unit 13 can be individually constructed by using recording mediums of databases or can be constructed as one physical recording medium.

In the medical data storing unit 12, various kinds of medical data, such as image data or the like, acquired by the medical image diagnosis apparatus 1 or other arbitrary apparatuses are stored in advance.

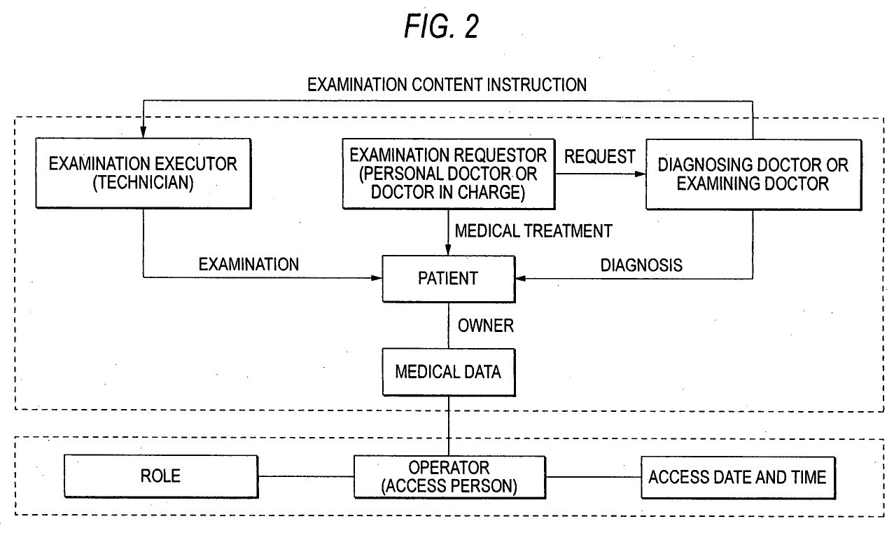

FIG. 2 is a conceptual view showing an example of the relationship among medical data, an access to which is controlled by the medical image diagnosis apparatus 1 shown in FIG. 1, a patient, an operator, and an access person.

As shown in FIG. 2, if a personal doctor or a doctor in charge as an examination requester requests an image examination, an examining doctor instructs a technician, who captures images as an examination executor, of specified examination contents, and the examination of a patient is performed by the technician. As a result, medical data, such as medical image data or the like, is obtained as personal information of the patient. Further, if necessary, the image diagnosis is performed by the examining doctor.

And then, if an operator (access person) accesses medical data, there are many cases in which it is appropriate to use the role of the access person or access date and time so as to judge accessibility, together with identification information of the access person.

In the operator attribute information storing unit 11, attribute information of the operator who accesses medical data stored in the medical data storing unit 12 is stored in advance as operator attribute information by operating the medical image diagnosis apparatus 1.

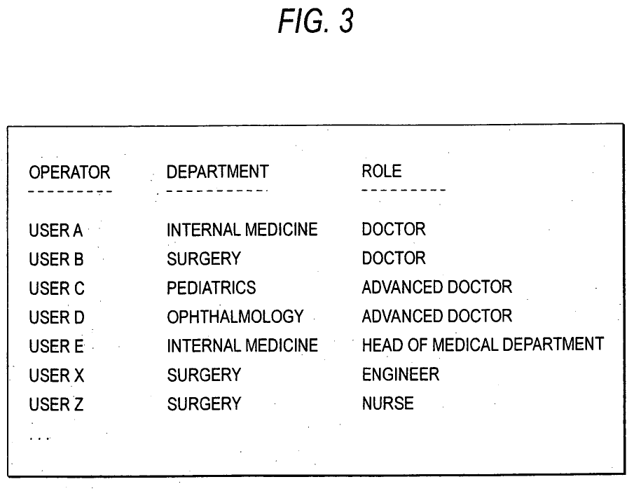

FIG. 3 is a diagram showing an example of the operator attribute information which is stored in the operator attribute information storing unit 11 of the medical image diagnosis apparatus 1 shown in FIG. 1.

As shown in FIG. 3, the operator attribute information includes department information representing a medical department (INTERNAL MEDICINE, SURGERY, PEDIATRICS, OPHTHALMOLOGY, and the like), role information (ROLE/GROUP) of the operator representing a role (DOCTOR, ADVANCED DOCTOR, HEAD OF MEDICAL DEPARTMENT, ENGINEER, NURSE, and the like) in association with identification information of the operator (USER A, USER B, and the like). Here, any information may be omitted from the operator attribute information or other arbitrary information may be added to the operator attribute information.

Further, in the data authorship information storing unit 13, authorship information of various kinds of medical data stored in the medical data storing unit 12 is stored as data authorship information.

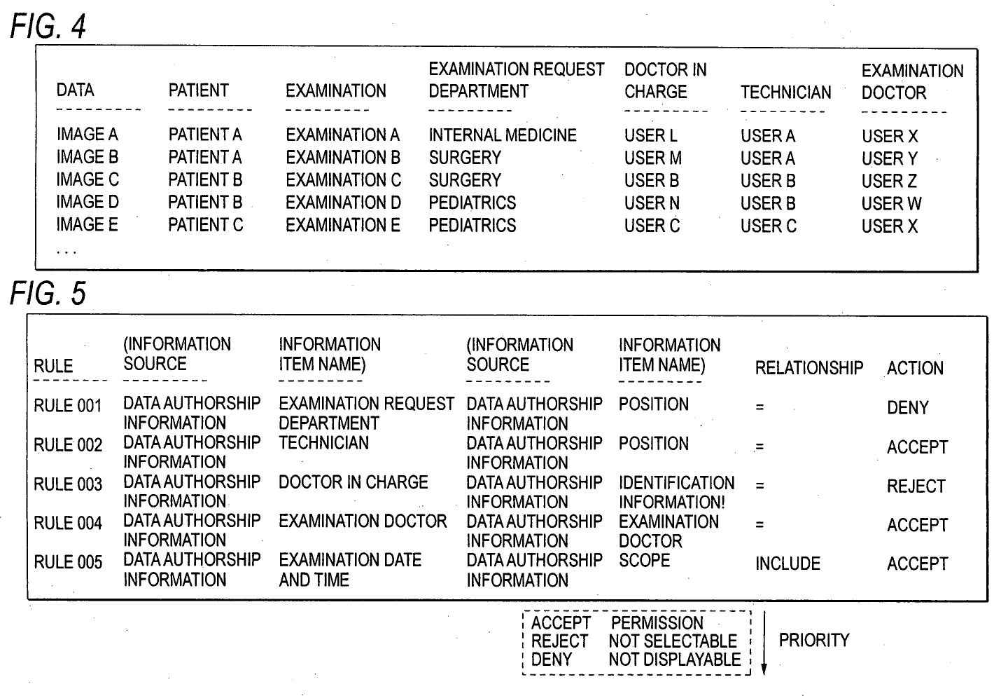

FIG. 4 is a diagram showing an example of the data authorship information which is stored in the data authorship information storing unit 13 of the medical image diagnosis apparatus 1 shown in FIG. 1.

As shown in FIG. 4, the data authorship information includes patient information representing a patient (PATIENT A, PATIENT B, PATIENT C, and the like) corresponding to medical image data, which is an example of medical data stored in the medical data storing unit 12, examination information representing an examination (EXAMINATION A, EXAMINATION B, EXAMINATION C, EXAMINATION D, EXAMINATION E, and the like) corresponding to medical image data, examination request department information representing a medical department (INTERNAL MEDICINE, SURGERY, PEDIATRICS, and the like) which requests the examination, doctor-in-charge information representing a doctor in charge (USER L, USER M, and the like) who requests the examination, technician information representing a technician (USER A, USER B, and the like) who captures images of medical image data, and examining doctor information representing an examining doctor (USER X, USER Y, USER Z, and the like) who instructs the examination in association with identification information (IMAGE A, IMAGE B, and the like) of medical image data, if necessary, with additional date information on which examination is executed. Here, any information may be omitted from the data authorship information or other arbitrary information may be added to the data authorship information.

In particular, it is useful to construct the data authorship information by using the authorship information of medical data, such as the doctor-in-charge information or the examining doctor information described above.

Further, the operator attribute information acquiring unit 5 has a function of receiving a request for the operator attribute information from the accessibility judging unit 10, acquiring the required operator attribute information from the operator attribute information storing unit 11, and giving the acquired operator attribute information to the accessibility judging unit 10.

The data authorship information acquiring unit 6 has a function of receiving a request for the data authorship information from the accessibility judging unit 10, acquiring the required data authorship information from the data authorship information storing unit 13, and giving the acquired data authorship information to the accessibility judging unit 10.

The access control information creating unit 8 has a function of constructing and creating the access control information for controlling the access of the operator to medical data stored in the medical image diagnosis apparatus 1 from one or both of the operator attribute information and the data authorship information, and a function of writing the created access control information into the access control information storing unit 7. Further, when creating the access control information, the access control information creating unit 8 can appropriately refer to the operator attribute information stored in the operator attribute information acquiring unit 5 and the data authorship information stored in the data authorship information acquiring unit 6.

FIG. 5 is a diagram showing an example of the access control information which is created by the access control information creating unit 8 of the medical image diagnosis apparatus 1 shown in FIG. 1.

As shown in FIG. 5, the access control information can be described, for example, in combination with five kinds of information. That is, the access control information can be described with five kinds of information of identification information of a rule for defining the access control, first attribute information having an information source and an information item name, second attribute information having an information source and an information item name, a specified condition (relationship), and an action (ACCEPT, REJECT, DENY, and the like) to be applied to the rule. At this time, the access control information can be described by an executable script language.

And then, with the access control information, an access control method is defined by a single rule or multiple rules such that a desired action is executed according to whether one or both of the first attribute information and the second attribute information satisfy a predetermined judgment condition.

Here, the judgment condition can be defined by a conditional statement using symbols, marks, or characters of a comparative operator, such as “=”, “ALL” representing all conditions, “!” inverting a condition, or the like.

Further, the action can be defined by a command statement, such as “ACCEPT”, “REJECT”, “DENY”, or the like. For example, when the operator wants to access medical image data, a list of medical image data can be displayed. And then, “ACCEPT” can be defined as an action which causes medical image data to be displayed in a list and to be selected when the judgment condition is satisfied. Further, “REJECT” can be defined as an action which performs access limitation for causing medical image data to be displayed in the list, but to be not selected when the judgment condition is satisfied. In addition, “DENY” can be defined as an action which performs access limitation for causing medical image data to be not displayed in the list when the judgment condition is satisfied.

For example, the access control condition defined by RULE 001 is a control condition in which ‘the action “DENY” is performed if the examination request department information included in the data authorship information as the first attribute information is the same as (=: equal to) the department information included in the operator attribute information as the second attribute information’. Further, the access control condition defined by RULE 002 is a control condition in which ‘the action “ACCEPT” is performed if the technician information included in the data authorship information as the first attribute information is the same as (=: equal to) the department information included in the operator attribute information as the second attribute information’.

In contrast with RULE 001, there may be a case in which the department information of the operator included in the operator attribute information and the examination request department information included in the data authorship information are different from each other. In this case, if the access control information (RULE) is created such that the access to medical image data is judged unpermitted, the access control can be performed such that an operator who does not belong to the medical department requesting the examination cannot access medical data. Further, specifically, RULE 002 is a rule by which, when the technician information included in the data authorship information and the identification information of the operator included in the operator attribute information are different from each other, the access to medical data is judged unpermitted. Accordingly, the access control can be performed such that a technician who does not execute the examination cannot access medical data.

Further, the access control condition defined by RULE 003 is a control condition in which ‘the action “REJECT” is performed if the doctor-in-charge information included in the data authorship information as the first attribute information is not the same as the identification information of the operator included in the operator attribute information as the second attribute information’. If the access limitation condition is set in such a manner, the access control can be performed such that an operator who is not a doctor in charge cannot select medical data. That is, the access control can be performed such that an operator who is not a doctor in charge requesting the examination cannot access medical data.

In addition, the access control condition defined by RULE 004 is a control condition in which ‘the action “ACCEPT” is performed if the examining doctor information included in the data authorship information as the first attribute information is the same as (=: equal, to) the examining doctor information included in the operator attribute information as the second attribute information’. Specifically, RULE 004 is a rule by which, when the examining doctor information included in the data authorship information and the examining doctor information included in the operator attribute information are different from each other, the access to medical data is judged unpermitted. If the access limitation condition is set in such a manner, the access control can be performed such that medical data can be selected when it is medical data of a patient whose examination content is instructed by the operator.

Further, as a rule, access date and time of the operator can be used to judge accessibility by using time-variant range information for the access condition. That is, the operator attribute information includes the time-variant range information defining a time-variant range which gives the access authority to the operator, and the data authorship information includes, for example, examination date and time representing date and time on which the examination is performed. And then, when the examination date and time does not fall within the time-variant range information, a rule can be created such that the access to medical data is judged unpermitted.

As a specified example, as shown in RULE 005, the first attribute information is defined with only in-examination, day examination, or past examination as a time-variant access scope of the operator attribute information. And then, the access control can also be performed such that the action is performed on the basis of the examination date and time included in the data authorship information. Specifically, as shown in FIG. 2, the access control information is described by using the access date and time information of the operator to medical data, as well as the relationship between an author and the operator as an access person. Accordingly, dynamic access control can be realized.

Moreover, when multiple rules exist, a priority can be arbitrarily set. For example, a method of setting a priority of an action in an order of “ACCEPT”, “REJECT”, and “DENY” of the rules, a method of setting a priority of an action in an order of the identification numbers of the rules, and a method of forming access control lists by the multiple rules, placing a priority on the newest rule in the common access control list, and placing a priority on “DENY” over other between different actions access control lists can be used.

Information required for creating the access control information can be given from the input device 2 to the access control information creating unit 8. However, a limitation can be made except in a case in which the input device 2 is operated by an operator who has a utilization authority of the access control information creating unit 8. In this case, the utilization authority of the access control information creating unit 8 itself can be defined by the access control information. Further, the access control information which describes the utilization authority of the access control information creating unit 8 once defined can be changed by the access control information creating unit 8.

And then, in the access control information storing unit 7, the access control information created by the access control information creating unit 8 is stored.

The access control information acquiring unit 9 has a function of acquiring the access control information from the access control information storing unit 7 and giving the acquired access control information to the accessibility judging unit 10.

The accessibility judging unit 10 has a function of judging accessibility of the operator to medical data on the basis of at least one of the operator attribute information received from the operator attribute information acquiring unit 5 and the data authorship information received from the data authorship information acquiring unit 6 and performing the access control to unpermitted medical data according to the access control information received from the access control information acquiring unit 9.

More specifically, the accessibility judging unit 10 has a function of creating information for causing a list, such as a patient list, a search list, or an image list, to be displayed for simple search of medical data to read (access) of medical data stored in the medical data storing unit 12 as list information on the basis of the identification information or role information of the operator received from the input device 2, and giving the created list information to the display device 3, such as a monitor or the like, to be displayed on the display device 3. Further, the accessibility judging unit 10 has a function of giving medical data stored in the medical data storing unit 12 to the display device 3, such as a monitor or the like, to be displayed on the display device 3 on the basis of a display instruction of medical data and the identification information or role information of the operator received from the input device 2. At the time of creating the list information or displaying medical data, medical data, such as medical image data or the like, stored in the medical data storing unit 12 or the data authorship information stored in the data authorship information acquiring unit 6 is referred to. In addition, if necessary, the access date and time by the operator is recorded in the accessibility judging unit 10 by the information received from the input device 2. The access date and time is referred to at the time of the accessibility judgment which is executed according to the display of the list information or medical data.

Further, when the list information is created and displayed or when medical data is displayed, the accessibility judging unit 10 has a function of acquiring the access control information from the access control information acquiring unit 9 as the list. With this function, the accessibility judging unit 10 is configured to judge accessibility to medical data according to each rule described in the access control information so as to create the list information or display medical data.

That is, the accessibility judging unit 10 acquires values representing the first attribute information and the second attribute information and evaluates by using the two values whether the judgment condition is satisfied (TRUE or FALSE) according to each rule described in the access control information. And then, if the evaluation result is TRUE, the action assigned in each rule is executed. At this time, the accessibility judging unit 10 requests the operator attribute information acquiring unit 5 or the data authorship information acquiring unit 6 information required for judging accessibility to medical data of the operator attribute information and the data authorship information and acquires the requested operator attribute information or data authorship information from the operator attribute information acquiring unit 5 or the data authorship information acquiring unit 6.

Moreover, when multiple rules are set, each rule can be used in the judgment in an order of the identification numbers of the rules. In this case, at the time of the rule to be applied whose action is to be executed, the judgment processing in the access control ends. Further, at the time of no rule, a default action can be executed.

Further, when the access control information is described by the executable script language, an external program corresponding to the script language is called by executing the script language. And then, the accessibility judgment is performed on the basis of the attribute information obtained by each external program.

In addition, with such a medical data access system 4, the medical image diagnosis apparatus 1 has a function of controlling the access of the operator to medical data.

Next, the operation of the medical image diagnosis apparatus 1 will be described.

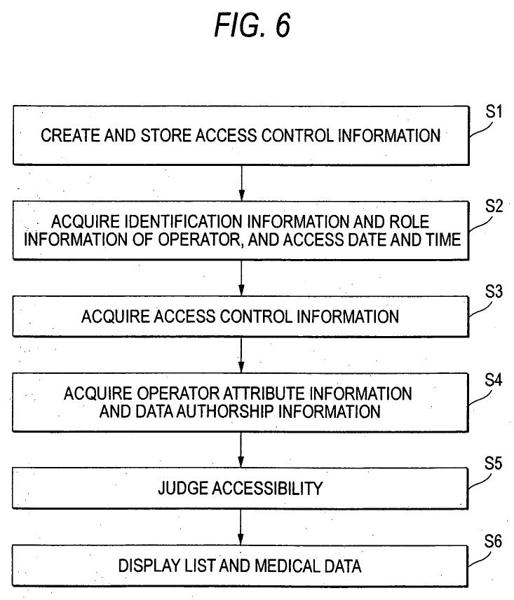

FIG. 6 is a flowchart showing a process when the access to medical data is performed by the medical image diagnosis apparatus 1 shown in FIG. 1. In FIG. 6, symbols of S with numerals attached thereto represent steps of the flowchart.

First, at a step S1, the access control information for controlling the access to medical data stored in the medical image diagnosis apparatus 1 is created and stored. That is, the information is given from the input device 2 to the access control information creating unit 8, and the access control information creating unit 8 creates the access control information which is described by the rules shown in FIG. 5. In addition, the access control information creating unit 8 writes the created access control information into the access control information storing unit 7. For this reason, in the access control information storing unit 7, the access control information created by the access control information creating unit 8 is stored.

Next, at a step S2, the operator of the medical image diagnosis apparatus 1 inputs to the input device 2 at least one of the identification information and the role information so as to access medical data stored in the medical data storing unit 12, for example, medical image data. From the input device 2, the request to access medical image data is given to the accessibility judging unit 10, together with the identification information or the role information of the operator. At this time, the accessibility judging unit 10 records the access date and time of the operator.

Next, at a step S3, the accessibility judging unit 10 gives the access control instruction to the access control information acquiring unit 9. The access control information acquiring unit 9 searches the access control information storing unit 7 on the basis of the request received from the accessibility judging unit 10 and acquires the access control information in a list format. In addition, the access control information acquiring unit 9 gives the acquired access control information to the accessibility judging unit 10. As a result, the accessibility judging unit 10 can acquires the access control information from the access control information acquiring unit 9 as the list.

Next, at a step S4, the accessibility judging unit 10 refers to the access control information acquired from the access control information acquiring unit 9, and requests the operator attribute information acquiring unit 5 or the data authorship information acquiring unit 6 the operator attribute information and the data authorship information described in the rule, that is, the operator attribute information and the data authorship information required for judging accessibility of the operator to medical image data.

For this reason, according to the request received from the accessibility judging unit 10, the operator attribute information acquiring unit 5 acquires the required operator attribute information from the operator attribute information storing unit 11, and gives the acquired operator attribute information to the accessibility judging unit 10. Further, according to the request received from the accessibility judging unit 10, the data authorship information acquiring unit 6 acquires the data authorship information from the data authorship information storing unit 13, and gives the acquired data authorship information to the accessibility judging unit 10.

As a result, the accessibility judging unit 10 can acquire the operator attribute information and the data authorship information required for judging accessibility of the operator to medical image data.

Next, at a step S5, the accessibility judging unit 10 refers to the acquired operator attribute information, data authorship information, and access date and time information, and judges accessibility of the operator to medical image data on the basis of the relationship between the authorship and the operator according to the access control information.

For example, when accessibility is judged according to RULE 001 of the access control information shown in FIG. 5, the examination request department information is extracted from the data authorship information of medical image data whose list is requested by the operator to be displayed for the sake of the access, and the department information is extracted from the operator attribute information of the operator. The extracted examination request department information and department information are represented by numeric values, and the accessibility judging unit 10 compares the two values with each other. And then, if both values are the same, the action “DENY” that list display is not performed is executed according to RULE 001.

As a result, at a step S6, according to the action to be executed as the result of the accessibility judgment, the accessibility judging unit 10 creates the list information for causing the list of medical image data to be displayed, and gives the created list information to the display device 3, such as a monitor or the like, to be displayed. For this reason, the operator can refer to the list displayed on the display device 3 and select a medical image to be displayed on the display device so as to input a display instruction from the input device 2. The display instruction of the medical image input to the input device 2 is given to the accessibility judging unit 10, and, if medical image data regarding the display instruction can be displayed according to the access control information, the accessibility judging unit 10 reads medical image data from the medical data storing unit 12 and gives medical image data to the display device 3, such as a monitor or the like, to be displayed.

That is, for example, in the access control information shown in FIG. 5, at the time of the action “DENY”, medical image data is not displayed in the list. Further, at the time of the action “REJECT”, medical image data is displayed in the list, but the selection for causing medical image data to be displayed cannot be performed. In addition, at the time of the action “ACCEPT”, the operator can select medical image data from the list to be displayed on the display device 3.

According to the above-described medical image diagnosis apparatus 1, the access control to medical data, such as medical image data or the like, can be dynamically performed according to the relationship between the authorship and the operator. Therefore, medical data, which is the personal information of the patient, can be easily and appropriately protected.

Moreover, the partial function or processing of the medical image diagnosis apparatus 1 may be omitted. Further, in the medical image diagnosis apparatus 1 shown as the embodiment, when the operator wants to access the data resource of medical data, that is, medical data stored in the medical data storing unit 12, the access control information representing the access authority to the data resource is acquired by the medical data access control system 4. Alternatively, when the operator logs in the medical image diagnosis apparatus 1, the medical data access control system 4 may collectively acquire the access control information, in which resources, such as the access authority of the operator, accessible data, or devices, are listed, as an access control list.

What is claimed is:

1. A medical apparatus comprising:
an operator attribute information storing unit that stores attribute information of an operator as operator attribute information;
a medical data storing unit that stores medical data;
a data authorship information storing unit that stores authorship information of medical data as data authorship information; and
an access control unit that performs access control so as to control an access of the operator to medical data by using the operator attribute information and the data authorship information.

2. A medical apparatus comprising:
an operator attribute information storing unit that stores attribute information of an operator as operator attribute information;
a medical data storing unit that stores medical data;
a data authorship information storing unit that stores authorship information of medical data as data authorship information;
an access control information creating unit that creates access control information so as to control an access of the operator to medical data by using at least one of the operator attribute information and the data authorship information;
an access control information storing unit that stores the access control information;
an access control information acquiring unit that acquires the access control information from the access control information storing unit;
an operator attribute information acquiring unit that acquires the operator attribute information required for judging accessibility according to the access control information acquired by the access control information acquiring unit from the operator attribute information storing unit;
a data authorship information acquiring unit that acquires the data authorship information required for judging accessibility according to the access control information acquired by the access control information acquiring unit from the data authorship information storing unit; and
an accessibility judging unit that judges accessibility of the operator to medical data on the basis of at least one of the operator attribute information received from the operator attribute information acquiring unit and the data authorship information received from the data authorship information acquiring unit according to the access control information received from the access control information acquiring unit, and performs access limitation to unpermitted medical data.

3. The medical apparatus according to claim 1,
wherein the operator attribute information storing unit is configured to store operator attribute information including department information representing a medical department to which the operator belongs, and
the data authorship information storing unit is configured to store data authorship information including examination request department information representing a medical department which requests an examination.

4. The medical apparatus according to claim 1,
wherein the operator attribute information storing unit is configured to store operator attribute information including identification information of the operator, and
the data authorship information storing unit is configured to store data authorship information including doctor-in-charge information representing a doctor in charge who requests an examination.

5. The medical apparatus according to claim 1,
wherein the operator attribute information storing unit is configured to store operator attribute information including identification information of the operator, and
the data authorship information storing unit is configured to store data authorship information including technician information representing a technician who captures images of medical data.

6. The medical apparatus according to claim 1,
wherein the data authorship information storing unit is configured to store data authorship information including examining doctor information representing an examining doctor who instructs an examination, and
the operator attribute information storing unit is configured to store operator attribute information including identification information of the examining doctor.

7. The medical apparatus according to claim 1,
wherein the operator attribute information storing unit is configured to store operator attribute information including time-variant range information, and
the data authorship information storing unit is configured to store data authorship information including examination date and time.

8. The medical apparatus according to claim 2,
wherein the access control information creating unit creates the access control information such that unpermitted medical data of medical data is not displayed in a list for selecting medical data which is displayed on a display device, and
the accessibility judging unit is configured to create list information such that unpermitted medical data is not displayed in the list.

9. The medical apparatus according to claim 2,
wherein the access control information creating unit creates the access control information such that unpermitted medical data of medical data cannot be selected from a list for selecting medical data which is displayed on a display device, and
the accessibility judging unit is configured to create list information such that unpermitted medical data cannot be selected from the list.

10. The medical apparatus according to claim 2,
wherein the operator attribute information includes department information representing a medical department to which the operator belongs, and the data authorship information includes examination request department information representing a medical department which requests an examination, and
the access control information creating unit creates the access control information such that the access to medical data is judged unpermitted when the department information of the operator and the examination request department information are different from each other.

11. The medical apparatus according to claim 2,
wherein the data authorship information includes doctor-in-charge information representing a doctor in charge who requests an examination, and the operator attribute information includes identification information of the operator, and
the access control information creating unit creates the access control information such that the access to medical data is judged unpermitted when the identification information of the operator and the doctor-in-charge information are different from each other.

12. The medical apparatus according to claim 2,
wherein the data authorship information includes technician information representing a technician who captures images of medical data, and the operator attribute information includes identification information of the operator, and
the access control information creating unit creates the access control information such that the access to medical data is judged unpermitted when the identification information of the operator and the technician information are different from each other.

13. The medical apparatus according to claim 2,
wherein the data authorship information includes examining doctor information representing an examining doctor who instructs an examination, and the operator attribute information includes identification information of the examining doctor, and
the access control information creating unit creates the access control information such that the access to medical data is judged unpermitted when the examining doctor information included in the data authorship information and the examining doctor information included in the operator attribute information are different from each other.

14. The medical apparatus according to claim 2,
wherein the operator attribute information includes time-variant range information, and the data authorship information includes examination date and time, and
the access control information creating unit creates the access control information such that the access to medical data is judged unpermitted when the examination date and time does not fall within the time-variant range information.

15. A method of controlling an access to medical data comprising:
storing attribute information of an operator as operator attribute information;
storing medical data;
storing authorship information of medical data as data authorship information; and
performing access control so as to control an access of the operator to medical data by using the operator attribute information and the data authorship information.

16. A method of controlling an access to medical data comprising:
creating access control information so as to control an access of an operator to medical data stored in a medical apparatus by using at least one of attribute information of the operator stored as operator attribute information and authorship information of medical data stored as data authorship information in the medical apparatus;
storing the access control information;
acquiring the access control information from the stored access control information;
acquiring the operator attribute information required for judging accessibility according to the acquired access control information;
acquiring the data authorship information required for judging accessibility according to the acquired access control information; and
judging accessibility of the operator to medical data on the basis of at least one of the acquired operator attribute information and data authorship information according to the acquired access control information, and performing access limitation to unpermitted medical data.

17. The method of controlling an access to medical data according to claim 15,
wherein the operator attribute information includes department information representing a medical department to which the operator belongs, and
the data authorship information includes examination request department information representing a medical department which requests an examination.

18. The method of controlling an access to medical data according to claim 15,
wherein the operator attribute information includes identification information of the operator, and
the data authorship information includes doctor-in-charge information representing a doctor in charge who requests an examination.

19. The method of controlling an access to medical data according to claim 15,
wherein the operator attribute information includes identification information of the operator, and
the data authorship information includes technician information representing a technician who captures images of medical data.

20. The method of controlling an access to medical data according to claim 15,
wherein the data authorship information includes examining doctor information representing an examining doctor who instructs an examination, and
the operator attribute information includes identification information of the examining doctor.

21. The method of controlling an access to medical data according to claim 15,
wherein the operator attribute information includes time-variant range information, and
the data authorship information includes examination date and time.

22. The method of controlling an access to medical data according to claim 16,
wherein the access control information is created such that unpermitted medical data of medical data is not displayed in a list for selecting medical data which is displayed on a display device, and list information is created such that unpermitted medical data is not displayed in the list.

23. The method of controlling an access to medical data according to claim 16,
wherein the access control information is created such that unpermitted medical data of medical data cannot be selected from a list for selecting medical data which is displayed on a display device, and list information is created such that unpermitted medical data cannot be selected from the list.

24. The method of controlling an access to medical data according to claim 16,
wherein the operator attribute information includes department information representing a medical department to which the operator belongs, and the data authorship information includes examination request department information representing a medical department which requests an examination, and
the access control information is created such that the access to medical data is judged unpermitted when the department information of the operator and the examination request department information are different from each other.

25. The method of controlling an access to medical data according to claim 16,
wherein the data authorship information includes doctor-in-charge information representing a doctor in charge who requests an examination, and the operator attribute information includes identification information of the operator, and
the access control information is created such that the access to medical data is judged unpermitted when the identification information of the operator and the doctor-in-charge information are different from each other.

26. The method of controlling an access to medical data according to claim 16,
wherein the data authorship information includes technician information representing a technician who captures images of medical data, and the operator attribute information includes identification information of the operator, and
the access control information is created such that the access to medical data is judged unpermitted when the identification information of the operator and the technician information are different from each other.

27. The method of controlling an access to medical data according to claim 16,
wherein the data authorship information includes examining doctor information representing an examining doctor who instructs an examination, and the operator attribute information includes identification information for identifying the examining doctor, and
the access control information creating unit creates the access control information such that the access to medical data is judged unpermitted when the examining doctor information included in the data authorship information and the examining doctor information included in the operator attribute information are different from each other.

28. The method of controlling an access to medical data according to claim 16,
wherein the operator attribute information includes time-variant range information, and the data authorship information includes examination date and time, and
the access control information is created such that the access to medical data is judged unpermitted when the examination date and time does not fall within the time-variant range information.
